(19) United States
(12) Patent Application Publication
(10) Pub. No.: US 2002/0139636 A1
(43) Pub. Date: Oct. 3, 2002

(54) Clutch driven disc friction material mounting

(76) Inventors: Daniel V. Gochenour, Auburn, IN (US); Michael L. Killian, Troy, MI (US)

Correspondence Address: KEVIN M. HINMAN, EATON CORPORATION, 26201 NORTHWESTERN, P.O. BOX 766, SOUTHFIELD, MI, 48037, US

(21) Appl. No.: 09/818,316

(22) Filed: Mar. 27, 2001

(51) Int. Cl. F16D 69/04

(52) U.S. Cl. 192/107 R; 219/91.2

(57) ABSTRACT

A clutch driven disc assembly includes a hub and an annular spring plate fixed to the hub. A friction disc assembly is mounted concentric with an axis of rotation of the hub and is rotatably relative to the spring plate. A plurality of drive springs are operably disposed between the spring plate and the friction disc assembly. The friction disc assembly further includes a reinforcing plate and a substantially annular disc fixed to the reinforcing plate. A friction material button is fixed to the substantially annular disc. The friction material button has a friction material cookie and a backer plate. The backer plate is fixed to the friction material cookie. The backer plate is substantially the same size and shape as the friction material cookie. A laser weld bead joins the substantially annular disc and the backer plate, in turn fixing the friction material button to the substantially annular disc.

### FIELD OF THE INVENTION

This invention relates in general to friction clutches and in particular to the structure of clutch driven discs.

### BACKGROUND OF THE INVENTION

Clutches are well known devices used to selectively connect a source of rotational power, such as the crankshaft of an internal combustion engine and its flywheel, to a driven mechanism, such as a transmission. Typically, clutches have a driven disc rotatably fixed to the transmission input shaft and are axially disposed between a flywheel and a pressure plate. Both the flywheel and the pressure plate are rotatably fixed to the output shaft of the engine. The pressure plate is axially biased toward the flywheel by an axial spring load. When the clutch is in an engaged condition, the pressure plate clamps the driven disc against the flywheel. Friction material is disposed on both sides of the driven disc to resist slipping between the driven disc and both the pressure plate and the flywheel. When the clutch is in a released condition, the axial spring load is overcome by a release mechanism, unclamping the driven disc. With the driven disc unclamped, relative rotation between the transmission input shaft and the engine output shaft or crankshaft becomes possible. When the clutch is reengaged, the pressure plate is pressed against the friction material, halting relative rotation between the engine output shaft and the transmission input shaft.

When the clutch is reengaged, and to a lesser degree when the clutch is released, the friction material wears due to the contact at relative speed with the pressure plate and flywheel.

Commonly, the friction material on the driven disc is provided in the form of a plurality of discrete elements or cookies. The cookies are adhesively bonded or brazed to metal plates to form friction material buttons. The buttons are in turn fixed to radially extending paddles of the driven disc assembly by rivets. The thickness of the rivet heads limits the amount of the friction material available for wear which can be usefully employed to provide engagement between the engine and the transmission. To compensate for the rivet head thickness, the friction material is made thicker than would otherwise be necessary. Also, the backer plate and the disc paddles are both larger than the cookies to enable the buttons to be riveted to the paddles at their outer edges.

Disadvantages of riveting the buttons to the paddles include: the need to provide the necessary extra thickness of friction material for clearing the rivet heads and the associated increased rotational inertia contributed by the friction material; and the extra rotational inertia attributable to the extra backer plate material and extra disc material used at the rivet locations.

It is desired to provide a driven disc with a reduced height attachment for friction material buttons which alternatively enables the use of thinner friction material cookies or extended wear of the friction material. It is also desired to provide a driven disc assembly having lower inertia.

It is also desired to provide a method of making a driven disc having a reduced height attachment for friction material buttons which enables the use of thinner friction material cookies, or, alternatively, enables the extended wear of the friction material. It is also desired to provide a method of making a driven disc having lower inertia.

### SUMMARY OF THE INVENTION

A clutch driven disc assembly includes a hub and an annular spring plate rotatably fixed to the hub. The hub has an axis of rotation. A friction disc assembly is mounted concentric with the axis of rotation for rotation relative to the spring plate. A plurality of drive springs are operably disposed between the spring plate and the friction disc assembly. The friction disc assembly further includes a reinforcing plate and a substantially annular disc fixed to the reinforcing plate. A friction material button is fixed to the substantially annular disc. The friction material button has a friction material cookie and a backer plate. The backer plate is fixed to the friction material cookie. The backer plate is substantially the same size and shape as the friction material cookie. A laser weld bead joins the substantially annular disc and the backer plate, in turn fixing the friction material button to the substantially annular disc.

A method for fabricating a clutch driven disc includes the steps of forming a hub, and rotatably fixing an annular spring plate to the hub concentric thereto. A friction disc assembly is mounted concentric with the hub for rotation relative to the spring plate. A plurality of drive springs are installed between the spring plate and the disc assembly. The friction disc assembly is formed by forming a reinforcing plate having spring pocket configured to receive the drive springs, by forming a substantially annular disc extending radially beyond the reinforcing plate, and fixing the substantially annular disc to the reinforcing plate. A backer plate is formed of steel. A cookie is formed out of friction material of substantially the same size and shape as the backer plate. The friction cookie is fixed to the backer plate to form a friction material button. The backer plate is laser welded to the substantially annular disc by directing a laser beam toward an interface between the backer plate and the substantially annular disc to form a plurality of weld beads between the backer plate and the substantially annular disc.

A method of fixing a friction material cookie to a driven disc paddle includes the steps of forming an annular disc having a radially extending paddle and forming a friction material cookie of substantially the same size as the paddle. A backer plate is formed of steel of substantially the size and shape as the cookie. The friction cookie is fixed to the backer plate to form a friction material button. The friction material button is laser welded to the annular disc, forming a plurality of laser weld beads at an interface between the backer plate and the annular disc.

The invention provides a clutch driven disc with a reduced height attachment for friction material buttons which alternatively enables the use of thinner friction material cookies or extended wear of the friction material. The invention also provides a driven disc assembly having lower inertia than a clutch driven disc employing rivets to join friction material buttons to the driven disc.

The invention additionally provides a method of making a driven disc having a reduced height attachment for friction material buttons enabling the use of thinner friction material cookies, or, alternatively, enabling the extended wear of the friction material. The invention provides a method of making a driven disc having lower inertia.

### BRIEF DESCRIPTION OF THE DRAWINGS

FIG. 1 is an end view of a clutch driven disc.

FIG. 2 is a sectional side view of the clutch driven disc of FIG. 1 in the direction of arrows 2.

FIG. 3 is an enlarged view of a paddle of the clutch driven disc of FIG. 1.

FIG. 4 is a sectional view of the portion of the clutch driven disc of FIG. 3 in the direction of arrows 4.

FIG. 5 is an enlarged view of a paddle of the clutch driven disc of FIG. 1 showing a first alternative welding configuration.

FIG. 6 is an enlarged view of a paddle of the clutch driven disc of FIG. 1 showing a second alternative welding configuration.

### DESCRIPTION OF PREFERRED EMBODIMENTS

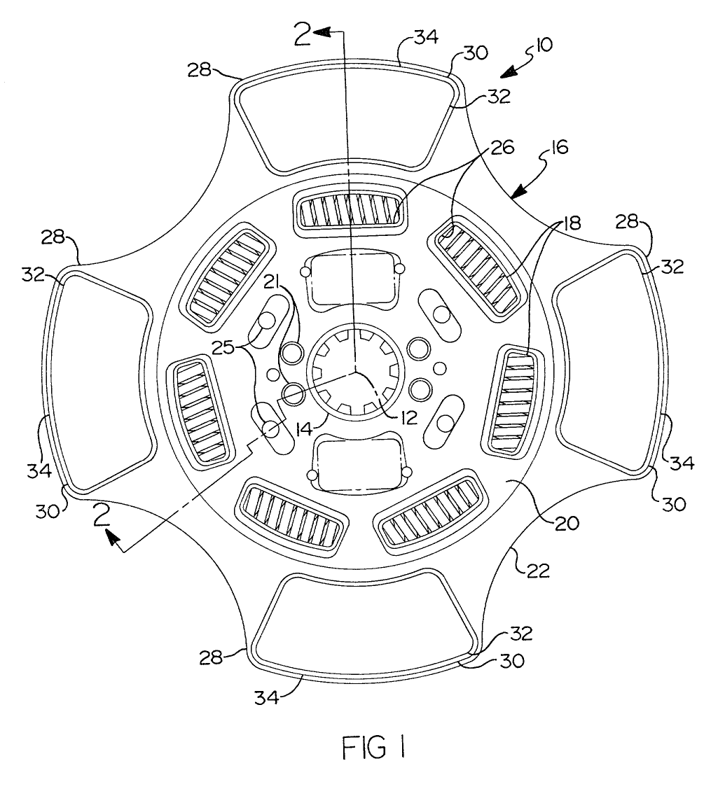

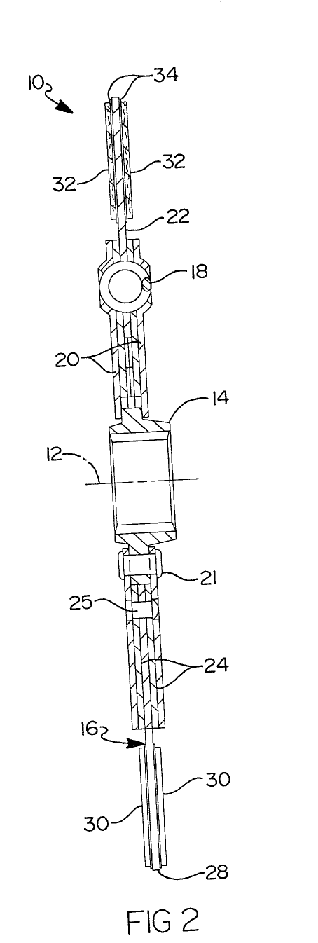

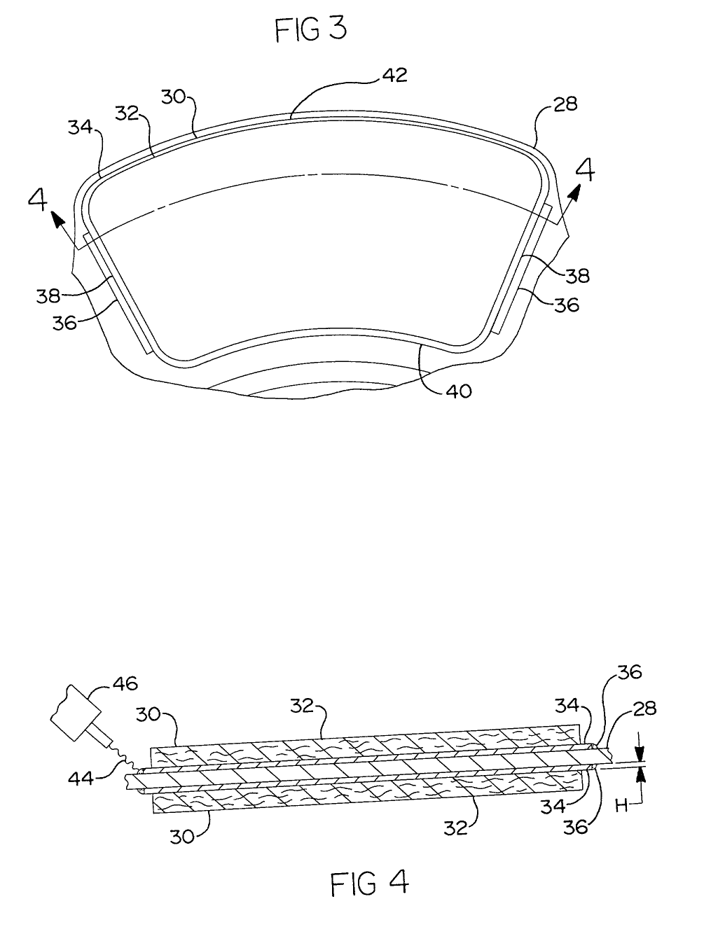

A clutch driven disc assembly 10 as shown in FIG. 1 and FIG. 2 includes an axis of rotation 12, a hub 14, a friction disc assembly 16 and a plurality of damping or drive springs 18 disposed between hub 14 and friction disc assembly 16.

A pair of spring plates 20 are fixed to hub 14 by rivets 21.

Friction disc assembly 16, best shown in FIG. 2, includes a substantially annular disc 22 fixed to a pair of annular reinforcing plates 24 by rivets 25 or other fastening means. Disc 22 is typically a plain carbon steel such as SAE 1080. Reinforcing plates 24 are axially disposed between spring plates 20. Drive springs 18 are disposed simultaneously in spring pockets 26 in reinforcing plates 24 and spring pockets in spring plates 20. Relative rotation of disc assembly 16 to hub 14 compresses drive springs 18.

Disc 22 has a plurality of radially extending paddles 28, best shown in FIG. 3. While four paddles 28 are shown, an alternative number of paddles 28 such as three may be employed. Friction buttons 30 are disposed on both sides of each paddle 28. Friction buttons 30 are used to provide frictional engagement with a clutch flywheel (not shown) and a clutch pressure plate (not shown) when installed in a vehicle.

Clutch friction buttons 30 include a friction material cookie 32, alternatively known as a compact and preferably made of an appropriate friction material, such as a sintered metallic composite or non-metallic materials, such as organic friction material. Such friction materials are well known in the art. Cookie 32 is fixed to a steel backer plate 34 by known means, such as adhesive bonding or by brazing. However, unlike the extended backer plate used for the riveted design, backer plate 34, as configured for attachment to paddle 28 in accord with the present invention, is substantially the same size and shape as friction material cookie 32. Buttons 30 are sized to substantially cover paddles 28. The corresponding size and shape of backer plate 34 relative to cookie 32 is enabled by eliminating the need for laterally extending rivet flanges. Backer plate 34 is formed of steel. Backer plate 34 is in turn laser welded to paddle 28. The number and placement of laser weld beads 36 is determined at least in part by the optimal number and location of laser weld beads 36 needed to prevent distortion of cookies 32 relative to paddles 28. Beads 36 are sized and oriented to prevent separation of buttons 30 from paddles 28. The laser weld bead or beads 36 are provided on at least two opposing edges of backer plates 34.

The weld beads 36 fuse backer plate 34 to paddle 28. Identical weld beads 36, in the embodiment shown in FIG. 3, are made on each lateral edge 38 of backer plate 34. Backer plate 34 extends slightly beyond cookie 32 to facilitate backer plate 34 being welded to paddle 28 without compromising either the friction material comprising cookie 32 or the attachment of cookie 32 to backer plate 34. Weld beads 36 have a low profile, seldom extending beyond the height H of backer plate 34.

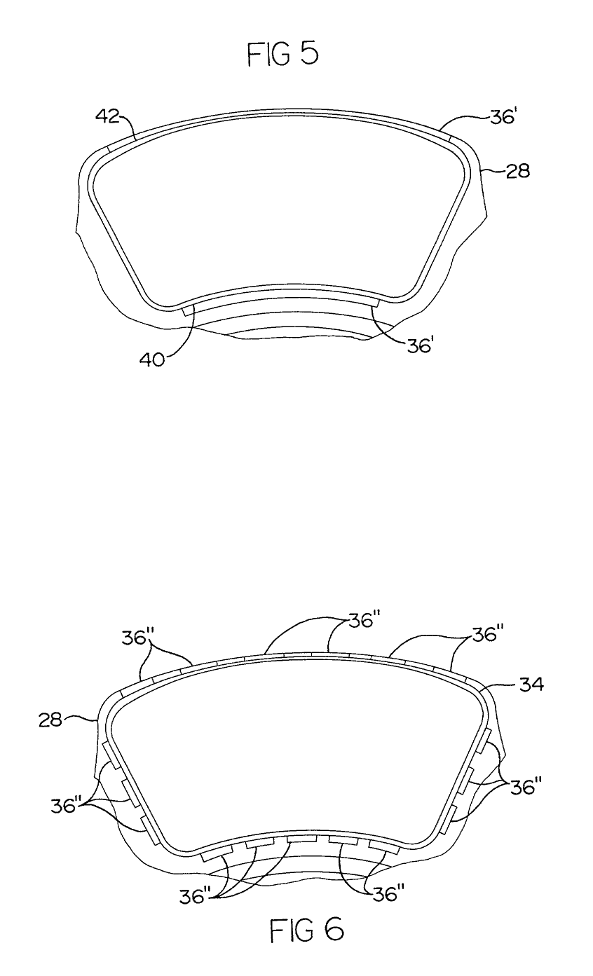

The placement and the number of weld beads can be varied from that shown in FIG. 3. One exemplary alternative embodiment shown in FIG. 5 locates weld beads 36′ along radially inner edge 40 and radially outer edge 42. Another alternative embodiment, as shown in FIG. 6, has a multitude of relatively short weld beads 36″ circumscribing backer plate 34. Yet alternatively, a single weld bead could extend continuously around the perimeter of backer plate 34. However, a continuous bead would likely be the most difficult and most expensive to provide.

A method for fabricating clutch driven disc assembly 10 is now described. Hub 14 is formed by conventional means, including stamping, forging, casting or other appropriate metal forming processes. Annular spring plates 20 are formed by an appropriate metal forming process, such as stamping, and are rotatably fixed to hub 14. Reinforcing plates 24 are stamped of steel and have spring pockets 26 formed therein configured to receive springs 18. Annular disc 22 is stamped of steel. Friction disc assembly 16 is assembled by riveting reinforcing plates 24 to annular disc 22. Friction disc assembly 16 is located concentric with spring plates 20 and hub 14 for rotation relative to spring plates 20 and hub 14. A plurality of drive springs 18 are installed between spring plates 20 and friction disc assembly 16.

A method for welding friction buttons 30 to disc 22 is now disclosed.

Laser weld beads 36 are formed by directing a beam 44 of coherent light of sufficient energy at or proximate to the interface between backer plate 34 and paddle 28. Beam 44 is generated by laser 46. The heat generated thereby fuses plate 34 and paddle 28 together. The fusing produces laser weld beads 36. Laser weld beads in general are characterized by a relatively small profile. The small profile is attributable to the autogenous nature of laser welding which requires no filer metal. While weld penetration may be deep, the resultant surface weld bead is relatively small since no filler material is added. It should be appreciated that the representation of welds in the figures are schematic and do not reflect weld penetration.

Laser welding is well suited for high production volumes. A laser welding system could be designed and built to generate multiple weld beads 36 simultaneously. While a multiple laser system may be complex, such systems are already in use in numerous other applications.

Advantages of driven disc assemblies 10 using the laser welding method over driven disc assemblies having buttons riveted to disc 22 include lower inertia, and increased clearances and lower cost. Inertia is reduced because backer plate 34 is smaller, being the same size as the friction material cookie, and because paddles 28 are smaller, and because there are no rivets and because friction material cookies 32 are thinner. If, instead of making paddles smaller to conform to the size of cookies 32, cookies are increased to the size of paddles, the useful life of driven disc assembly 10 is increased. Welds 38 do not extend significantly beyond backer plate 34, as no filler metal is added. Deformation of cookies 32 during welding is reduced relative to other forms of welding because of the precise nature of laser welding. This precision is due in part to the high energy density of the laser beam. Further, due to the ability to accurately locate and form the laser weld, the resultant weld beads 36 are relatively small. As a result, little heat is transferred to the backer plate beyond the immediate area of the weld, thereby minimizing the potential for distortion being created by welding.

Another benefit of the present invention is a reduction in the variable cost of fabricating a clutch driven disc assembly 10. Lower variable cost is obtained by the elimination of the rivets which would otherwise be needed to retain cookies 30, by a reduction in the amount of friction material needed, by a reduction in the amount of backer plate material due to the smaller size of the backer plate, and by a reduction in the amount of disc material needed due to the smaller paddle areas.

The embodiments disclosed herein have been discussed with the purpose of familiarizing the reader with the novel aspects of the invention. Although preferred embodiments of the invention have been shown and disclosed, many changes, modifications and substitutions may be made by one having ordinary skill in the art without necessarily departing from the spirit and scope of the invention as described in the following claims.

We claim:

1. A clutch driven disc assembly comprising:
a hub having an axis of rotation;
an annular spring plate rotatably fixed to the hub;
a friction disc assembly mounted concentric with the axis of rotation for rotation relative to the spring plate;
a plurality of drive springs operably disposed between the spring plate and the friction disc assembly;
the friction disc assembly including:
a reinforcing plate having spring pockets receiving the drive springs;
a substantially annular disc fixed to the reinforcing plate; and
a friction material button fixed to the substantially annular disc and comprising:
a friction material cookie,
a backer plate fixed to the friction material cooker of substantially the same size and shape as the friction material cookie,
a laser weld bead joining the substantially annular disc and the backer plate which fixes the friction material button to the substantially annular disc.

2. A clutch driven disc assembly as claimed in claim 1 wherein the laser weld bead is of a height no greater than a height of the backer plate.

3. A clutch driven disc assembly as claimed in claim 1 wherein the substantially annular disc has a plurality of radially extending paddle areas, and both the friction material and the backing plate are substantially the same size as the paddle areas.

4. A method for fabricating a clutch driven disc including the steps of:
forming a hub;
rotatably fixing an annular spring plate to the hub concentric thereto;
mounting a friction disc assembly concentric with the hub for rotation relative to the spring plate;
installing a plurality of drive springs between the spring plate and the disc assembly;
forming the friction disc assembly by:
forming a reinforcing plate having spring pockets configured to receive the drive springs;
forming a substantially annular disc extending radially beyond the reinforcing plate;
fixing the substantially annular disc to the reinforcing plate; and
forming a backer plate of steel;
forming a cookie out of friction material of substantially the same size and shape as the backer plate;
fixing the friction cookie to the backer plate to form a friction material button;
laser welding the backer plate to the substantially annular disc by directing a laser beam toward an interface between the backer plate and the substantially annual disc to form a plurality of weld beads between the backer plate and the substantially annular disc.

5. A method of forming a clutch driven disc as claimed in claim 4 wherein the resultant laser weld bead is of a height no greater than a height of the backer plate.

6. A method of forming a clutch driven disc as claimed in claim 4 wherein the substantially annular disc is provided with a plurality of radially extending paddle areas, and the friction material buttons are substantially the same size as the paddle areas.

7. A method of fixing a friction material cookie to a driven disc paddle including the steps of:
forming an annular disc having a radially extending paddle;
forming a friction material cookie of sintered metal of substantially the same size as the paddle;
forming a backer plate of steel of substantially the same size and shape as the cookie;
fixing the friction cookie to the backer plate to form a friction material button;
laser welding the friction material button to the annular disc, forming a plurality of laser weld beads between the backer plate and the annular disc.
